(19) United States
(12) Patent Application Publication
(10) Pub. No.: US 2022/0264947 A1
(43) Pub. Date: Aug. 25, 2022

(54) CARTRIDGE FOR DISPENSING PRODUCTS AND METHODS FOR THEIR MANUFACTURE

(71) Applicants: Angus RITTENBURG, Perkasie, PA (US); GOOD DESIGN, INC., Vancouver (CA)

(72) Inventor: Angus RITTENBURG, Perkasie, PA (US)

(21) Appl. No.: 17/597,755

(22) PCT Filed: Jul. 22, 2020
(86) PCT No.: PCT/US2020/043055

§ 371 Date: Jan. 21, 2022

Related U.S. Application Data
(60) Provisional application No. 62/876,972, filed on Jul. 22, 2019.

(51) Int. Cl. A24F 40/42; A24F 40/485; A24F 40/70; A24F 40/10

(52) U.S. Cl. CPC A24F 40/42; A24F 40/485; A24F 40/70; A24F 40/10

(57) ABSTRACT

A pressurized cartridge housing is disclosed having at least one of a pressurized gas, pressurized liquid, botanical extract, flavor additive or enhancer, dye, anti-fungal, diluent or solvent, among other compounds and compositions suitable for human consumption or contact.

### CROSS REFERENCE TO RELATED PATENT APPLICATIONS

The subject matter of the instant invention is related to U.S. Provisional Patent Application No. 62/876,965, filed Jul. 22, 2020, and entitled “BEVERAGE DISPENSING APPARATUS AND METHODS FOR PREPARING BEVERAGES”; the disclosure of which is hereby incorporated by reference.

### FIELD OF THE INVENTION

The present invention is directed to the field of containers suitable for packaging, storing and dispensing products that are suitable for human contact and consumption.

### BACKGROUND OF THE INVENTION

Products that contain a variety of ingredients must be formulated to be stable for the entire shelf life of the product. In cases where different ingredients are not miscible, expensive processing methods must be employed to alter ingredients and make them stable once combined. This not only increases the cost of the end-product; it can also alter the quality and taste of the combined ingredients. There is a need in the art for a device that can combine ingredients immediately prior to consumption or human contact.

Various devices use a combination of pressure and liquid or gas flow to combine ingredients while a user is dispensing a product. These devices typically require multiple inputs such as electricity, batteries, water, flavor pods/packets, and pressurized gas cartridges, among other things. The process of collecting all the items required to use such devices can be irksome for consumers and requires a permanent arrangement that is not easy to transport and use. There is a need in the art for a device that consumers can use to quickly produce their own consumable products anywhere. By consumable products, it is meant to refer to beverages, food additives, respirable compositions, among other products suitable for human consumption or contact.

Many flavors and other food ingredients suffer from degradation due to oxidation when exposed to atmospheric air (e.g., during storage). To limit the degree of oxidation, foods and beverages are often enclosed in a sealed package. The shortcoming of this solution is that many foods and beverages must be consumed within a short timeframe of opening the sealed package. This is particularly problematic for packages containing multiple servings of high value product. There is a need in the art for a food and beverage packaging solution that does not suffer from these shortcomings.

In addition, various pharmaceuticals, drugs, other medicaments, and precursors thereof are not readily miscible with water which makes it difficult, if not impossible, to mix these ingredients into a palatable beverage or store for extended periods of time. In addition, certain ingredients must be protected from oxygen and UV light or they will degrade. There is a need in the art for a device that can combine ingredients at the time of consumption to overcome these shortcomings.

### SUMMARY OF THE INVENTION

This invention solves problems associated with conventional devices by providing a pressurized cartridge housing at least one of a pressurized gas, pressurized liquid, at least one active ingredient, flavor additive or enhancer, dye, anti-fungal, diluent or solvent, among other compounds and compositions suitable for human consumption or contact. By “active ingredient” it is meant to refer to at least one of botanical extracts, pharmaceuticals, drugs, other medicaments, nutrients, animal extracts, microbial extracts, precursors thereof, among others.

One embodiment of the present invention is directed to a composition comprising at least one active ingredient and at least one of a pressurized gas, pressurized liquid, flavor additive, dye, anti-fungal, and diluent, wherein the composition is suitable for human consumption and contact.

One embodiment of the invention relates to any combination of the foregoing embodiments wherein the pressurized gas or pressurized liquid comprises at least one member selected from the group consisting of carbon dioxide and nitrogen.

Another embodiment of the invention relates to any combination of the foregoing embodiments wherein a container comprising a composition comprising at least one active ingredient and at least one of a pressurized gas, pressurized liquid, flavor additive, dye, anti-fungal, and diluent, wherein the composition is suitable for human consumption and contact.

One embodiment of the invention relates to any combination of the foregoing embodiments wherein the container complies with 49 CFR 173.304 (2016) as well as 49 CFR 173.301 (2002); the disclosure of which is hereby incorporated by reference.

One embodiment of the invention relates to any combination of the foregoing embodiments wherein at least one of the active ingredient and at least one of a flavor additive, dye, anti-fungal, and diluent are contained within the housing.

A further embodiment of the invention relates to combining at least one active ingredient (e.g., an oil such as cannabidiol oil) and liquid (e.g., water, alcohol containing fluid, juice, tea, among other consumable liquids) at the time of consumption to create a mixture.

A further embodiment of the invention relates to combining at least one degassed active ingredient (e.g., an oil such as cannabidiol oil) and degassed liquid (e.g., water, alcohol containing fluid, juice, tea, among other consumable liquids) at the time of consumption to create an emulsion (e.g., a stable oil in water emulsion). By “stable” it is meant that the ingredient is emulsified within a liquid phase.

Another embodiment of the invention relates to a method for filling or refilling a container having a cap wherein the container comprises a valve member having a seal member located between the valve and the cap member and a flexible member that biases the valve into a closed position; the method comprises, applying a force to the valve that is sufficient to move the valve relative to the cap and towards an interior of the container thereby moving the valve from a closed to an open position, introducing a composition into the interior of the container through an opening defined in the interior end of the valve member; and, releasing the force thereby moving the valve from the open to the closed position.

A further embodiment of the invention relates to a method for dispensing a composition from a container having a cap wherein the container comprises a valve member having a seal member located between the valve and the cap member and a flexible member that biases the valve into a closed position, the method comprises, applying a force to the valve that is sufficient to move the valve relative to the cap and towards the interior of the container thereby moving the valve from a closed to an open position, releasing the composition from the interior of the container through an opening defined in the interior end of the valve member; wherein the composition is under pressure and moving the valve releases the pressure thereby dispensing the composition.

The various embodiments of the invention can be used alone or in combinations with each other along with other features disclosed herein and within the scope of the appended claims. Other features and advantages of the present invention will be apparent from the following more detailed description, taken in conjunction with the accompanying drawings which illustrate, by way of example, the principles of the invention.

### BRIEF DESCRIPTION OF THE DRAWINGS

FIG. 1 is an isometric perspective of the inventive cartridge with flavor additive and extract inside.

FIG. 2 is a front perspective of the cartridge with a flavor/extract cartridge connected inline.

FIG. 3 is a bottom perspective and cross section of the cartridge of FIG. 2 that illustrates one member or system for dispensing or releasing the contents of the cartridge.

FIG. 4 is an enlarged, partial cross-section of member or system of the cartridge of FIG. 3.

Wherever possible, the same reference numbers will be used throughout the drawings to represent the same parts.

### DETAILED DESCRIPTION OF THE INVENTION

This invention provides a means for packaging ingredients in a cartridge that contains a pressurized gas or liquid phase, or a combination of phases. This invention also provides a means for manufacturing the cartridge and dispensing the contents of the cartridge. This invention is useful in that it provides a means for preserving ingredients in a cartridge with the ability to dispense and combine the contents with other solids, liquids, and gasses without an external power source. The cartridge can be used to combine preserved ingredients with other ingredients at the time of dispense, which can extend the shelf life for many products. The cartridge can be made to comply with the filling requirements of 49 CFR 173.304 (2016) as well as the shipment requirements of 49 CFR 173.301 (2002); the disclosure of which are hereby incorporated by reference.

In one embodiment of the invention, flavoring is stored in the cartridge with a gas at high pressure. The flavoring would be preserved under the blanket of the gas (i.e., a gas that is not reactive with the flavoring) since no oxygen is present to oxidize the flavors. While any suitable flavoring can be employed, examples of flavoring comprise at least one member selected from the group consisting of ginger, fern, cloudberry, dandelion, elderflower, marshmallow, and coffee. The pressurized gas could also be under pressure and then be used to push the flavoring out of the cartridge when needed. As another example, cannabis extracts such as CBD oils could be put in a cartridge with liquified gas. When used in an apparatus, the pressurized gas could be used to encourage mixing of the cartridge contents and a liquid by allowing the gas cartridge contents to expand in a turbulent manner through the liquid. By gas it is meant to refer to nitrogen, carbon dioxide, among other non-oxidizing gas suitable for human consumption. By high pressure it is meant about 100 to about 1000 psi, about 250 to about 750 psi, or any pressure suitable for mixing and dispensing the contents of the bottle. By non-oxidizing it is meant that the cartridge contains less than about 1 volume % oxygen, less than about 0.5 volume %, greater than about 0 to about 0.2 volume % or other oxidizing gases or compounds or compositions. In a particular embodiment, about 3 grams of hemp extract is placed into a cartridge containing 2 ml C02 at 100 psi. The amount of active ingredient (e.g., hemp including cannabidiol (CBD) oil, cannabis, or other botanical or drug) can range from about 1 mg to about 20 mg, about 20 mg to about 40 mg and in some cases about 40 to about 200 mg. The amount of liquid CO2 can range from about 1 g to about 8 g, about 8 g to about 12 g and in some cases about 12 g to about 90 g. If a flavor is added, the amount of flavor can range from about 1 mg to about 1 g, about 1 g to about 50 g and in some cases about 50 g to about 200 g. The cartridge could be used to add an active ingredient to 1 liter of beverage liquid using the inventive apparatus. The inventive apparatus could then be used to dispense an active ingredient (e.g., hemp) infused beverage.

The invention also provides a means for storing liquids and/or solids in a pressurized gas cartridge that can be released and suspended in a gaseous environment. For example, a gas cartridge could be pressurized with compressed gas or liquid (including air) and an active ingredient (e.g., volatile oils). The cartridge could be used in an apparatus that slowly releases the active ingredient by misting or vaporizing into the environment around it. This would enable a portable device that does not require any inputs other than the cartridge itself.

The invention also provides a means for storing a degassed ingredient (e.g., active ingredient containing liquids and/or solids) in a pressurized gas cartridge that can be injected into a degassed liquid (e.g., an aqueous fluid) within a container. By storing degassed ingredients in the cartridge and degassed liquid in a separate container and combining at the time of consumption, one can achieve homogenous mixing of typically immiscible ingredients (e.g., oil and water). In one example, degassed oil and degassed water are combined causing a homogenous mixture of 100 micron oil droplets in water for over 3 hours. Prior to instant invention, such a combination can only be achieved with such stability by using surfactant which negatively affect the flavor and bioavailability of the solution. Degassing can be achieved by using any suitable equipment and methods including, sonication, pressure reduction/vacuum, among conventional degassing technologies.

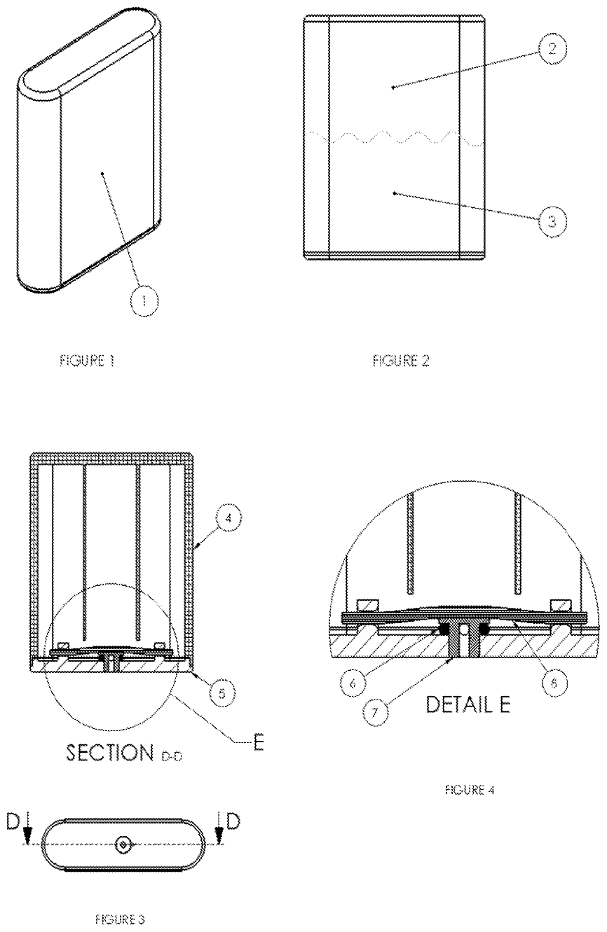

Referring now to FIGS. 1-2, FIGS. 1-2 illustrates an embodiment of the invention wherein a cartridge (1) contains a liquified or pressurized gas (2) and a composition comprising at least one active ingredient (3). The compositions (3) are made to be mixed and preserved in the liquified gas (2). The composition (3) can also be made to be preserved under a blanket gas (2). In a particular embodiment, the composition can be degassed prior to being added to the cartridge (1), and the remaining volume (2) can be created to keep the compositions (3) degassed. A dye or any form of colorant can be used in the contents of the cartridge as a form of verification that the product is not counterfeit or otherwise altered. It is to be understood that the gas (2) can be in any phase. The cartridge (1) can be made to maximize ergonomics and convenience for transportation and storage.

Referring now to FIG. 3, FIG. 3 illustrates a cross section and detailed views of the cartridge (1) of FIGS. 1-2. A container (4) has a cap (5) which is affixed and hermetically sealed to keep the contents within. A convenient shape that is suitable for high pressure contents is created by adding structural internal ribs within container (4).

Referring now to FIG. 4, FIG. 4 illustrates a valve mechanism that can be used to release the contents of the container (1). A seal member (6) is compression fit between a valve member (7) and the cap member (5). Valve member (7) is movable relative to the cap (5) and towards the interior of container (4). A spring member (8) can be added to bias valve member (7) into a closed position and, if desired, spring member (8) permits refilling the cartridge by forcing a seal between the valve member (7) and the cap member (5). Spring member (8) can have any suitable configuration such as a steel strip, wire, among other configurations and is flexibly mounted on an interior surface of cap (5) by slots, clips, among other retaining members. When the valve member (7) is forced upward by an external rigid member, the seal between valve member (7) and cap member (5) is broken, which causes the flavor and extracts (3) as well as the gas (2) to flow from the interior of container (4) through an opening defined in the interior end of the valve member (7) and out of the cartridge (1) by exiting an orifice defined on an exterior end of valve member (7). The valve member (7) can be made to create a high velocity stream of flavor and extracts favorable for mixing into an external volume of liquid.

The invention further provides a means for manufacturing a gas cartridge containing gas, flavor, active ingredient (e.g., botanical extract), and/or any other ingredients. First, a container, for example, as illustrated in FIGS. 1 and 2, is formed by plastic injection molding. Next, an end cap is formed by plastic injection molding. A valve member can also be formed by plastic injection molding. A seal is made by an injection process such as liquid silicone rubber injection. Next, the valve member is inserted into the cap component with the seal. The container component is then filled with a pre-mixed solution of liquid gas, a composition comprising at least one active ingredient, flavor, extracts, and/or other ingredients. As one example, a cartridge approximately 26×26×6 mm could be filled with 4 grams of liquid nitrogen, flavors, and active ingredient (e.g., cannabis extracts). The cap is then affixed to the container by any suitable method. As one example, the cap could be ultrasonically welded to the container member providing an instant structural hermetic seal. The cartridge can be decorated by either adding a pattern to the injection mold, adding a stick, or painting the cartridge, among other things.

While the invention has been described with reference to a preferred embodiment, it will be understood by those skilled in the art that various changes may be made, and equivalents may be substituted for elements thereof without departing from the scope of the invention. In addition, many modifications may be made to adapt a situation or material to the teachings of the invention without departing from the essential scope thereof. Therefore, it is intended that the invention not be limited to the embodiment disclosed as the best mode contemplated for carrying out this invention, but that the invention will include all embodiments falling within the scope of the appended claims.

What is claimed is:

1. A composition comprising at least one degassed active ingredient and at least one of a pressurized gas, pressurized liquid, flavor additive, dye, anti-fungal, and diluent, wherein the composition is suitable for human consumption and contact.

2. The composition of claim 1 wherein the degassed active ingredient comprises botanical extract comprises Cannabidiol (CBD).

3. The composition of claim 1 wherein the degassed active ingredient comprises botanical extract comprises Tetrahydrocannabinol (THC).

4. The composition of claim 1 wherein the pressurized gas or pressurized liquid comprises at least one member selected from the group consisting of carbon dioxide and nitrogen.

5. A container comprising a composition comprising at least one degassed active ingredient and at least one of a pressurized gas, pressurized liquid, flavor additive, dye, anti-fungal, and diluent, wherein the composition is suitable for human consumption and contact.

6. The container of claim 5 wherein the container complies with 49 CFR 173.304 (2016) as well as 49 CFR 173.301 (2002).

7. The container of claim 5 further comprising a housing affixed to an end of the container for dispensing the composition.

8. The container of claim 5 wherein at least one of the degassed active ingredient and at least one of a flavor additive, dye, anti-fungal, and diluent are contained within the housing.

9. The container of claim 5 wherein the degassed active ingredient comprises botanical extract comprises Cannabidiol (CBD).

10. The container of claim 5 wherein the degassed active ingredient comprises botanical extract comprises Tetrahydrocannabinol (THC).

11. A housing which contains a package containing at least one of degassed active ingredient and at least one of flavor additives, dye, anti-fungal, and diluent, wherein the housing defines an opening which permits a pressurized source of fluid to contact and extract at least a portion of the contents of the package.

12. The housing of claim 11 wherein the active ingredient comprises botanical comprises Cannabidiol (CBD).

13. The housing of claim 11 wherein the active ingredient comprises botanical comprises Tetrahydrocannabinol (THC).

14. The container of claim 6 wherein the housing comprises the housing of claim 11.

15. The housing of claim 11 wherein the opening is defined within an valve member mounted in a cap sealed to the housing.

16. The housing of claim 15 wherein the valve is biased into a closed position by a flexible member.

17. A method for manufacturing the container of claim 5 comprising forming the container from an injection molded plastic, introducing the composition into the container, sealing the container and affixing a housing.

18. A method for filling or refilling a container having a cap wherein the container comprises a valve member having a seal member located between the valve and the cap member and a flexible member that biases the valve into a closed position; the method comprises,
applying a force to the valve that is sufficient to move the valve relative to the cap and towards an interior of the container thereby moving the valve from a closed to an open position,
introducing a composition into the interior of the container through an opening defined in the interior end of the valve member; and,
releasing the force thereby moving the valve from the open to the closed position.

19. A method for dispensing a composition from a container having a cap wherein the container comprises a valve member having a seal member located between the valve and the cap member and a flexible member that biases the valve into a closed position, the method comprises,
applying a force to the valve that is sufficient to move the valve relative to the cap and towards the interior of the container thereby moving the valve from a closed to an open position,
releasing the composition from the interior of the container through an opening defined in the interior end of the valve member; wherein the composition is under pressure and moving the valve releases the pressure thereby dispensing the composition.

20. A composition comprising at least one active ingredient and at least one of a pressurized gas, pressurized liquid, flavor additive, dye, anti-fungal, and diluent, wherein the composition is suitable for human consumption and contact.

21. The composition of claim 20 wherein the active ingredient comprises botanical extract comprises Cannabidiol (CBD).

22. The composition of claim 20 wherein the active ingredient comprises botanical extract comprises Tetrahydrocannabinol (THC).

23. The composition of claim 20 wherein the pressurized gas or pressurized liquid comprises at least one member selected from the group consisting of carbon dioxide and nitrogen.

24. A container comprising a composition comprising at least one active ingredient and at least one of a pressurized gas, pressurized liquid, flavor additive, dye, anti-fungal, and diluent, wherein the composition is suitable for human consumption and contact.

25. The container of claim 24 wherein the container complies with 49 CFR 173.304 (2016) as well as 49 CFR 173.301 (2002).

26. The container of claim 24 further comprising a housing affixed to an end of the container for dispensing the composition.

27. The container of claim 24 wherein at least one of the active ingredient and at least one of a flavor additive, dye, anti-fungal, and diluent are contained within the housing.

28. The container of claim 24 wherein the active ingredient comprises botanical extract comprises Cannabidiol (CBD).

29. The container of claim 24 wherein the active ingredient comprises botanical extract comprises Tetrahydrocannabinol (THC).

30. A housing which contains a package containing at least one of active ingredient and at least one of flavor additives, dye, anti-fungal, and diluent, wherein the housing defines an opening which permits a pressurized source of fluid to contact and extract at least a portion of the contents of the package.

31. The housing of claim 30 wherein the active ingredient comprises botanical comprises Cannabidiol (CBD).

32. The housing of claim 30 wherein the active ingredient comprises botanical comprises Tetrahydrocannabinol (THC).

33. The container of claim 24 wherein the housing comprises the housing of claim 30.

34. The housing of claim 30 wherein the opening is defined within an valve member mounted in a cap sealed to the housing.

35. The housing of claim 30 wherein the valve is biased into a closed position by a flexible member.
